(19) United States
(12) Patent Application Publication
(10) Pub. No.: US 2011/0119631 A1
(43) Pub. Date: May 19, 2011

(54) METHOD AND APPARATUS FOR OPERATING USER INTERFACE BASED ON USER'S VISUAL PERSPECTIVE IN ELECTRONIC DISPLAY DEVICE

(75) Inventor: Kyu Hyun CHO, Hwaseong-si (KR)

(73) Assignee: SAMSUNG ELECTRONICS CO. LTD., Suwon-si (KR)

(21) Appl. No.: 12/945,016

(22) Filed: Nov. 12, 2010

(30) Foreign Application Priority Data
Nov. 13, 2009 (KR) 10-2009-0109776

(51) Int. Cl. G06F 3/048

(52) U.S. Cl. 715/848

(57) ABSTRACT

A method and apparatus for operating a three-dimensional user interface in an electronic display device, according to a user's visual perspective from which a user looks at the device, are provided. In the method, the apparatus activates a three-dimensional mode in response to a user's request, and determines the user's visual perspective according to a predefined user's input received in the three-dimensional mode. Then the apparatus displays a user interface converted according to the user's visual perspective.

### PRIORITY

This application claims the benefit under 35 U.S.C. §119(a) of a Korean patent application filed on Nov. 13, 2009 in the Korean Intellectual Property Office and assigned Serial No. 10-2009-0109776, the entire disclosure of which is hereby incorporated by reference.

### BACKGROUND OF THE INVENTION

1. Field of the Invention

The present invention relates to an electronic display device. More particularly, the present invention relates to a method and apparatus for operating a user interface, based on a user's visual perspective, in an electronic display device.

2. Description of the Related Art

With advances in technology, a great variety of electronic devices have been developed and introduced. Normally, these devices offer various user interfaces by which a user interacts with such devices. The User Interface (UI) provides a means of input, allowing a user to manipulate a device, and a means of output, allowing a device to indicate the effects of a user's manipulation. With the advancements of electronic devices, the UI is increasingly evolving into a user-friendly and more intuitive interface under various environments.

However, most conventional devices offer only two-dimensional user interfaces in a static form, thus failing to give stereoscopic (three-dimensional) visual effects to a user. Although three-dimensional user interfaces are available in some devices, such interfaces usually require a user's manipulation to handle three-dimensional graphic objects. In particular, such conventional user interfaces may be operated regardless of a user's visual perspective from which the user looks at the device.

Thus, a need exists for a method and device for displaying a three-dimensional user interface depending on a user's visual perspective.

### SUMMARY OF THE INVENTION

An aspect of the present invention is to address the above-mentioned problems and/or disadvantages and to provide at least the advantages described below.

Another aspect of the present invention is to provide a method and apparatus for operating a three-dimensional user interface in an electronic display device, according to a user's visual perspective from which the user looks at the device.

Yet another aspect of the present invention is to provide a method and apparatus for capturing a user's image in an electronic display device, acquiring zone information from the captured image, and then rotating a user interface in a three-dimensional manner, according to the acquired zone information.

Still another aspect of the present invention is to provide a method and apparatus for determining display information according to zone information acquired from image data obtained by an electronic display device, and then intuitively displaying a three-dimensional user interface adapted to a user's visual perspective by rotating the user interface according to the determined display information.

In accordance with an aspect of the present invention, a method for operating a user interface is provided. The method includes activating a three-dimensional mode in response to a user's request, determining a user's visual perspective according to a predefined user's input received in the three-dimensional mode, and displaying a user interface converted according to the user's visual perspective.

In accordance with another aspect of the present invention, an electronic device is provided. The device includes a display unit configured to display a user interface, a detecting member configured for providing input information for a three-dimensional conversion of the user interface, and a control unit configured determining a user's visual perspective based on the input information and for controlling a conversion of the user interface according to the user's visual perspective.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1 to 3 are schematic views illustrating examples of an electronic display device according to exemplary embodiments of the present invention.

FIG. 4 is a block diagram illustrating the configuration of an electronic display device according to an exemplary embodiment of the present invention.

FIG. 5 is a flow diagram illustrating a method for operating a user interface based on a user's visual perspective in an electronic display device according to an exemplary embodiment of the present invention.

FIG. 6 is a view illustrating a way to acquire zone information in an electronic display device according to an exemplary embodiment of the present invention.

FIG. 7 is a view illustrating examples of a user interface according to display information determined using the zone information shown in FIG. 6 according to an exemplary embodiment of the present invention.

FIG. 8 is a view illustrating possible variations in a user interface of an electronic display device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the exemplary embodiments of the present invention.

In brief, this invention provides a Graphical User Interface (GUI) of an electronic display device varied in real time according to a user's visual perspective from which the user looks at the device. Exemplary embodiments of the present invention provide a method and apparatus for converting a two-dimensional user interface into a three-dimensional user interface according to a user's visual perspective.

Exemplary embodiments of this invention may be applied to all kinds of electronic display devices, each of which has a display unit and an input unit. More particularly, electronic display devices for exemplary embodiments of the present invention may include communication devices, multimedia players, and their application equipment, including a mobile device having a relatively small display unit and a display device having a relatively large display unit.

A mobile device may include many types of mobile communication terminals based on various communication protocols, a Portable Multimedia Player (PMP), a digital broadcasting player, a Personal Digital Assistant (PDA), a music player (e.g., a Motion Picture Experts Group Audio Layer 3 (MP3) player), a portable game console, a smart phone, and the like. Meanwhile, a display device may include a TeleVision (TV), a notebook, a personal computer, a Large Format Display (LFD), a Digital Signage (DS), a media pole, etc.

A display unit may be formed of a Liquid Crystal Display (LCD), a Plasma Display Panel (PDP), Organic Light Emitting Diodes (OLED), and any other equivalent. An input unit may be formed of a camera module, but is not limited thereto. An input unit is to create input information required for controlling variations in a three-dimensional user interface, and hence may be formed of a touchpad or touch screen and an additional controller, such as a remote controller. Such a remote controller may have a keypad for receiving a user's key input, or may alternatively have a gyro sensor, an accelerometer, an InfraRed Light Emitting Diode (IR-LED), or an image detector for determining a motion or a pointing gesture.

An apparatus according to the following exemplary embodiment captures a user's image through a camera module and then acquires zone information from the captured image. Also, the apparatus determines display information according to the acquired zone information and then offers in real time a graphical user interface adapted to the user's visual perspective according to the determined display information. As discussed above, the apparatus may employ another input unit instead of the camera module to obtain input information for determining display information.

Now, an electronic display device and a method for operating a user interface in the device will be described in detail. The following embodiments are, however, exemplary only, and are not to be considered as a limitation of the present invention.

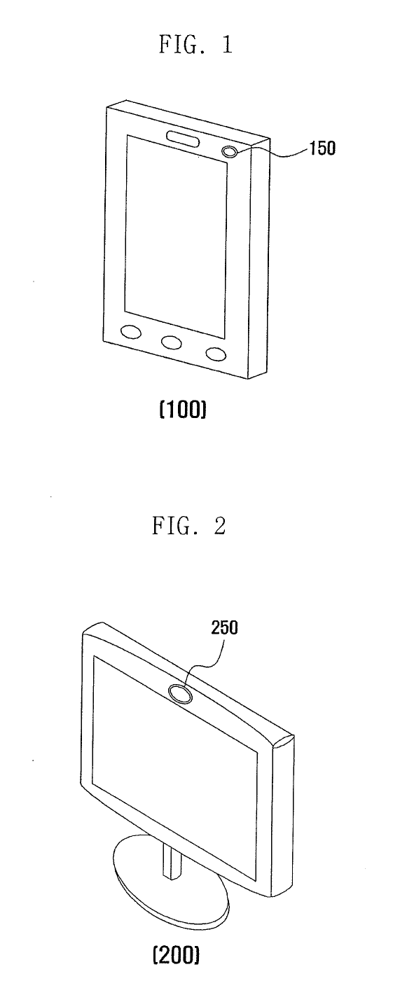

FIGS. 1 to 3 are schematic views illustrating examples of an electronic display device according to exemplary embodiments of the present invention.

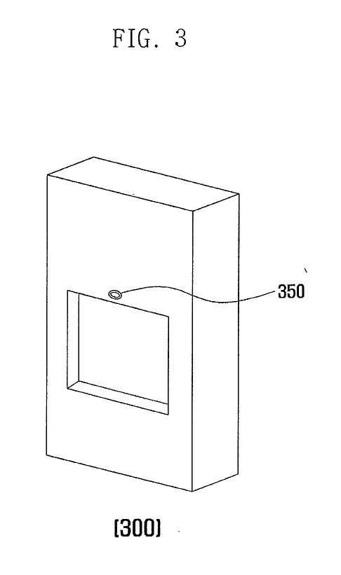

Referring to FIGS. 1 to 3, FIG. 1 shows a mobile device 100, FIG. 2 shows a TV 200 as a kind of a display device, and FIG. 3 shows a media pole 300 as another kind of a display device.

The mobile device 100 shown in FIG. 1 may include, as discussed above, mobile communication terminals, a PMP, a digital broadcasting player, a PDA, a music player, a portable game console, a smart phone, and the like. In addition, the mobile device 100 may have a camera module 150 embedded therein or attached thereto that receives input information required for variations in a user interface based on a user's visual perspective.

The TV 200 shown in FIG. 2 is an example of a large-sized display device. As discussed above, such a display device may include a notebook, a personal computer, and the like. Also, this display device may have a camera module 250 embedded therein or attached thereto that receives input information required for variations in a user interface based on a user's visual perspective.

The media pole 300 or a screen monitor shown in FIG. 3 is an example of a display device used for on-screen navigation systems or guidance systems. This display device is installed on a wall, a pillar or the ground in a museum, a gallery, an amusement park, a street, etc. This display device may also have a camera module 350 embedded therein or attached thereto that receives input information required for variations in a user interface based on a user's visual perspective.

Meanwhile, if input information is created using a touchpad, touch screen, a remote controller, etc., the aforesaid camera modules 150, 250 and 350 may be omitted in the devices 100, 200 and 300.

As shown in FIGS. 1 to 3, the device according to exemplary embodiments of this invention may include all kinds of devices capable of converting a two-dimensional user interface into a three-dimensional user interface adapted to a user's visual perspective. Namely, the device according to an exemplary embodiment of the present invention may include midsize or larger devices as well as portable smaller devices. Therefore, although the mobile device 100 is used in the following exemplary description, any other of various types of devices as discussed above may also be applied to this invention. More particularly, in order to operate variations in a user interface according to a user's visual perspective, the device according to an exemplary embodiment of the present invention may use a variety of input information, such as zone information acquired through a camera module, touch information acquired through a touchpad or touch screen, remote information acquired through a remote controller, voice information acquired through a microphone, motion information acquired through a motion sensor, and their composite information.

Therefore, the device may have at least one of the above-mentioned detecting members, namely a camera module, a voice input device such as a microphone, a motion sensor, a touch-based input device such as a touchpad or touch screen, etc. Of course, the device may have a composite structure of the above elements.

Now, an electronic display device according to an exemplary embodiment of this invention will be described in detail. Although the mobile device is used in the following description, this is exemplary only and not to be considered as a limitation of this invention.

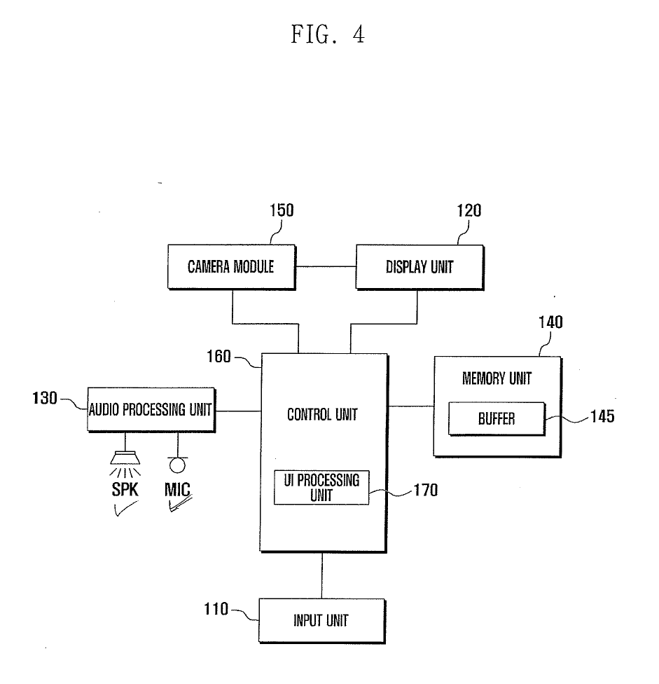

FIG. 4 is a block diagram illustrating a configuration of an electronic display device according to an exemplary embodiment of the present invention.

Referring to FIG. 4, the device of this invention includes an input unit 110, a display unit 120, an audio processing unit 130, a memory unit 140, a camera module 150, and a control unit 160. The audio processing unit 130 may have a speaker (SPK) and microphone (MIC). The control unit 160 may have a User Interface (UI) processing unit 170. Now, each individual element of the device will be described in detail.

The input unit 110 creates an input signal for entering letters and numerals and an input signal for setting or controlling functions of the device, and then delivers them to the control unit 160. The input unit 110 includes a plurality of input keys and function keys to receive a user's input and to set various functions. The function keys may include navigation keys, side keys, shortcut keys, and any other special keys defined to perform particular functions. The input unit 110 may be formed of one or a combination of a touchpad, a touch screen, a keypad having a normal key layout (e.g., a 3*4 key layout), and a keypad having a qwerty key layout. More particularly, the input unit 110 may create input information for converting a user interface according to a user's visual perspective and then send it to the control unit 160. Here, input information may be displayed in the form of a key signal by a manipulation of navigation keys, or a touch signal by a touch on a touchpad or touch screen.

The display unit 120 represents a variety of information inputted by a user or displayed to a user, including various screens activated by execution of functions of the device. For instance, the display unit 120 may visually output a boot screen, an idle screen, a menu screen, a list screen, a play screen, and the like. The display unit 120 may be formed of LCD, PDP, OLED, or any other equivalent. In addition, the display unit 120 may be formed of a touch screen that acts together both as input and output units. In this case, the aforesaid input unit 110 may be omitted from the device, and also the display unit 120 may offer touch information for converting a user interface to the control unit 160. In particular, the display unit 120 displays a user interface that is rotated stereoscopically according to a user's visual perspective under the control of the control unit 160.

The audio processing unit 130 may include a speaker (SPK) for outputting audio signals of the device and a microphone (MIC) for collecting audio signals, such as a user's voice. The audio processing unit 130 changes an audio signal received from the microphone (MIC) into data and then outputs it to the control unit 160, and also outputs an audio signal inputted from the control unit 160 through the speaker (SPK). Additionally, the audio processing unit 130 may output any other various audio signals (e.g., audio signals in a data playback or sound effects in a function execution) produced in the device. More particularly, the audio processing unit 130 may output given sound effects when a user interface is converted.

The memory unit 140 stores a variety of data and applications created and used in the device, including data produced when a particular function of the device is performed (e.g., call log data, phonebook data, music data, image data, broadcast data, photo data, message data, menu data, etc.), data received from other entities (e.g., a web server, other device, etc.), applications required for directly performing particular functions or menus, and the like.

Additionally, the memory unit 140 may store software related to the conversion of a user interface according to a user's visual perspective. The memory unit 140 may store setting information in connection with the use of the device and the conversion of a user interface. Here, setting information may contain input information (e.g., zone information, etc.), display information, conversion information, a mapping table of display information according to input information, and the like. Also, display information may have conversion information about a user interface (e.g., rotation angle information, rotation direction information, etc.). Namely, the memory unit 140 may store setting information in which rotation angles and directions are defined for a three-dimensional user interface for each virtual zone. Also, the memory unit 140 may store various user interface views determined according to input information and display information.

Furthermore, the memory unit 140 may include at least one buffer 145 that temporarily stores data produced while functions of the device are performed. For instance, the memory unit 140 may perform a buffering for input information (e.g., zone information) acquired when a user interface is converted according to a user's visual perspective, and for display information determined according to input information. The memory unit 140 may be internally formed in the device, or externally attached, such as a smart card. Namely, many kinds of internal/external storages may be used for the memory unit 140, such as Random Access Memory (RAM), Read Only Memory (ROM), a flash memory, a multi-chip package memory, and the like.

The camera module 150 acquires an image of a target object under the control of the control unit 160 and then sends the acquired image to the display unit 120 and the control unit 160. Normally, the camera module 150 converts light inputted through a camera lens into digital data in a sensor. More specifically, the camera module 150 may include a camera sensor (not shown) that converts an optical signal into an electric signal, and a signal processor (not shown) that converts an electric signal into digital data. The camera sensor may be a Charge-Coupled Device (CCD) sensor or a Complementary Metal Oxide Semiconductor CMOS sensor. The camera sensor and the signal processor may be merged together or separately formed. In particular, zone information, a kind of input information, may be produced from image data acquired through the camera module 150.

Meanwhile, although the exemplary device shown in FIG. 4 uses the camera module 150 to acquire zone information required for a conversion of a three-dimensional user interface, the present invention is not limited thereto. As discussed above, any other detecting members such as a motion sensor, a touchpad, a touch screen, a microphone, a remote controller, etc., may be used to acquire user-related input information required for a conversion of a user interface according to a user's visual perspective. Therefore, the device of this invention may acquire input information such as zone information through at least one of the above sensing members. For instance, motion information based on a motion sensor, touch information based on a touchpad or touch screen, voice information based on a microphone, remote information based on a remote controller, and the like, may replace zone information based on the camera module 150.

The control unit 160 performs whole control functions for the device and also controls the flow of signals in respective elements of the device. Namely, the control unit 160 controls the signal flow among the input unit 110, the display unit 120, the audio processing unit 130, and the memory unit 140.

More particularly, the control unit 160 not only controls a display of a two-dimensional user interface, but also controls a display of a three-dimensional user interface converted according to a user's visual perspective as determined by input information. Namely, the control unit 160 performs a series of control processes related to a display of a normal user interface, and also performs a series of control processes related to a display of a stereoscopic user interface based on a user's visual perspective. Additionally, the control unit 160 produces input information in response to a user input when operating a display function of a user interface based on a user's visual perspective, and then determines display information according to the input information. Furthermore, the control unit 160 controls a conversion and display of a user interface according to determined display information. The control unit 160 may produce, as input information, one of zone information, touch information, remote information, voice information, and motion information, according to conditions for producing user inputs.

Additionally, the control unit 160 may include a UI processing unit 170 used for converting a user interface according to a user's visual perspective. The UI processing unit 170 operates a three-dimensional user interface. For instance, the UI processing unit 170 processes a conversion of a three-dimensional user interface based on display information determined by the control unit 160. Namely, the UI processing unit 170 checks display information determined by the control unit 160 and then retrieves conversion information to be used for a conversion into a three-dimensional user interface. Then the UI processing unit 170 converts a currently displayed user interface into a three-dimensional user interface according to retrieved conversion information and displays it on the display unit 120. More specifically, the UI processing unit 170 produces values of conversion information on X, Y, and Z axes and determines a rotation angle and direction of a user interface by using a coordinate value composed of the X, Y, and Z values. Then the UI processing unit 170 performs a three-dimensional rendering of a user interface to display it according to a user's visual perspective. Such processing functions of the UI processing unit 170 may be realized with software and loaded in the control unit 160. In other words, the control unit 160 may include functions of the UI processing unit 170.

Meanwhile, the control unit 160 may control the cameral module 150 and the UI processing unit 170 when receiving a signal for activating a three-dimensional mode from one of the input unit 110, a touch screen of the display unit 120, a microphone of the audio processing unit 130, and the like.

As discussed heretofore, the control unit 160 may control the entirety of the operations in connection with a conversion and display of a user interface based on a user's visual perspective. Also, the above-discussed control functions may be realized with software having a proper algorithm and loaded in the control unit 160.

Meanwhile, a device of this invention is not limited to the exemplary configuration shown in FIG. 4. For instance, the control unit 160 of the device may have a baseband module used for a mobile communication service, and in this case the device may further include a wireless communication module.

In addition, although not illustrated in FIG. 4, a device of this invention may essentially or selectively include any other elements, such as a short distance communication module, a wired or wireless data transmission interface, an Internet access module, a motion sensor, a digital broadcast receiving module, and the like. According to a digital convergence tendency today, such elements may be varied, modified, and improved in various ways, and any other elements equivalent to the above elements may be additionally or alternatively equipped in the device. Meanwhile, as will be understood by those skilled in the art, some of the above-mentioned elements in the device may be omitted or replaced with another.

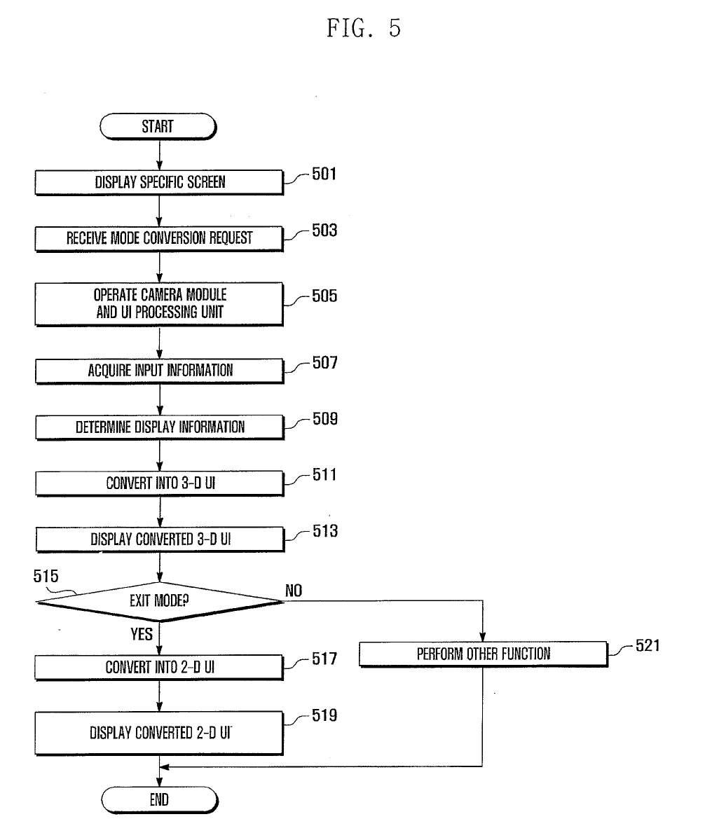

Now, a method for operating a user interface of exemplary embodiments of the present invention and related examples will be described in detail, with reference to FIGS. 5 to 8. The following is, however, exemplary only, and not to be considered as a limitation of this invention.

FIG. 5 is a flow diagram illustrating a method for operating a user interface based on a user's visual perspective in an electronic display device according to an exemplary embodiment of the present invention.

Referring to FIG. 5, the control unit 160 of the device displays a specific screen in response to a user's request in step 501. More specifically, the control unit 160 selects a particular function at a user's request, and then displays the specific screen predefined corresponding to a selected function on the display unit 120. Here, the specific screen may be an idle screen, a menu screen, a list screen, a call screen, a video play screen, etc., and may be displayed on a two-dimensional user interface.

Next, the control unit 160 receives a user's request for a mode conversion (e.g., a three-dimensional mode conversion) while the above-discussed specific screen is displayed on the display unit 120 in step 503. Here, the mode conversion request may be a three-dimensional mode request for converting a user interface of the specific screen into a three-dimensional user interface according to conversion information corresponding to a user's visual perspective. Therefore, the control unit 160 may activate a three-dimensional mode when receiving a mode conversion request. More particularly, the three-dimensional mode makes a user interface displayed on the display unit 120 coincide with a user's visual perspective and thus gives an effect as if a user looks at the user interface straight in the eye without rotating the device itself.

The mode conversion request may be produced by means of an input signal from one of the input unit 110, a touch screen of the display unit 120, a microphone (MIC) of the audio processing unit 130, a motion sensor, and the like. For instance, at a user's request, the input unit 110 may create an input signal for requesting a mode conversion, or alternatively the display unit 120 may create a touch signal for requesting a mode conversion when using a touch screen. In addition, if the device further has a certain detector, such as a gyro sensor or an accelerometer, such a detector may create a detection signal. Then, based on the detection signal, the control unit 160 may determine a change in location, acceleration, or tilt of the device and interpret it as a request for a mode conversion.

Next, when receiving the mode conversion request, the control unit 160 begins to operate the camera module 150 and the UI processing unit 170 in step 505. In this step, if the camera module 150 has already been enabled, the control unit 160 may perform a procedure only required for operating the UI processing unit 170.

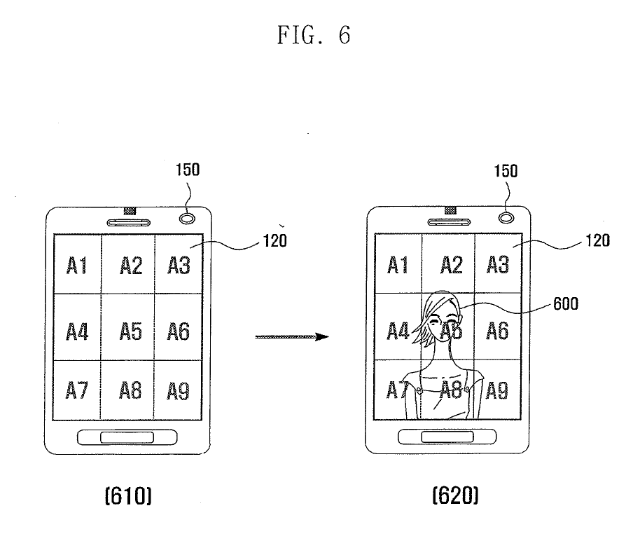

Next, the control unit 160 acquires input information about a user's visual perspective from a user input in step 507. More specifically, the control unit 160 acquires the user's image data through the camera module 150, and then retrieves zone information from the acquired image data. Here, zone information may be location values of image data (especially, face data) on the display unit 120. Related descriptions will be given later with reference to FIG. 6.

Meanwhile, if a user input is a touch signal produced in a touch screen, the control unit 160 may acquire input information corresponding to zone information from the touch signal. Similarly, if a user input is a remote signal produced in a remote controller, the control unit 160 may acquire input information corresponding to zone information from the remote signal. Also, if the device further has some detector such as a gyro sensor or an accelerometer, the control unit 160 may acquire input information corresponding to zone information from a change in location, acceleration, or tilt of the device.

Next, the control unit 160 determines display information from the acquired zone information in step 509. Here, the display information may contain conversion information required for a three-dimensional conversion of a currently displayed user interface according to the zone information. For instance, the display information may contain rotation angle information and rotation direction information for rendering stereoscopic effects to a user interface displayed on the display unit 120.

Next, the control unit 160 converts a current user interface displayed on the display unit 120 into a three-dimensional user interface according to the determined display information in step 511. Then the control unit 160 controls the display unit 120 to display the converted three-dimensional user interface in step 513. Specifically, the UI processing unit 170 of the control unit 160 checks the determined display information and then retrieves conversion information to be used for a conversion into a three-dimensional user interface. In addition, the UI processing unit 170 converts a current user interface into a three-dimensional user interface according to the retrieved conversion information and then displays it on the display unit 120. Here, the UI processing unit 170 may retrieve rotation angle information and rotation direction information by referring to conversion information and a mapping table of display information per input information. Also, the UI processing unit 170 performs a three-dimensional rendering of a user interface to display it according to a user's visual perspective.

Next, the control unit 160 determines whether there is a request for exiting the three-dimensional mode in step 515. Here, the mode exit request may be produced by means of the same input signal as used for the mode conversion request in the aforesaid step 503.

Next, if there is no request for exiting the three-dimensional mode, the control unit 160 may perform another function in step 521. For instance, the control unit 160 checks variations in zone information, determines display information according to the zone information, converts a user interface according to the display information, and then controls the display unit to display the converted user interface. Also, the control unit 160 may perform a particular function such as a menu navigation, a video file play, sub-menu activation, a message writing, etc. in response to a user's request. Also, the control unit 160 may initialize a function of a user interface display based on a user's visual perspective in response to the user's request, and then newly display a user interface corresponding to an idle screen or a specific screen of a function to have been earlier performed. Here, the three-dimensional mode may be also initialized, and thus a user interface may be displayed in a two-dimensional form.

On the other hand, if there is a request for exiting the three-dimensional mode, the control unit 160 converts a current three-dimensional user interface into a two-dimensional user interface in step 517. Then the control unit 160 controls the display unit 120 to display the converted two-dimensional user interface in step 519. At this time, graphic objects that compose a user interface may correspond to those that compose a specific screen displayed earlier in the initial step 501. For instance, if a user interface displayed in the step 501 is a menu screen, the same menu screen may be displayed again as a user interface in this step 519.

The above-discussed method may be controlled by the control unit 160 of the device shown in FIG. 4, or by software loaded in the control unit 160.

Now, examples of screen views used for offering the above-discussed user interface will be described in detail with reference to FIGS. 6 to 8.

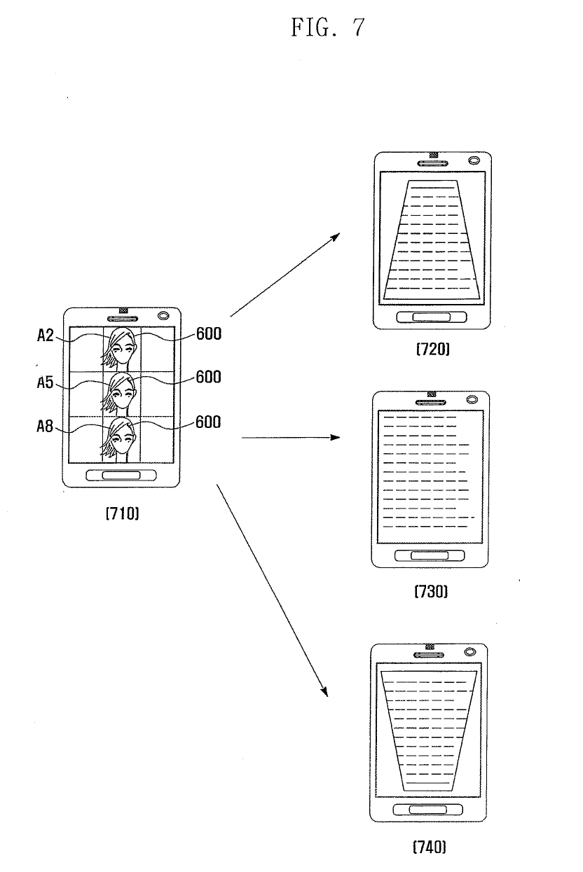

FIG. 6 is a view illustrating a method to acquire zone information in an electronic display device according to an exemplary embodiment of the present invention. Additionally, FIG. 7 is a view illustrating examples of a user interface according to display information determined using the zone information shown in FIG. 6.

Referring to FIG. 6, as shown in screen views 610 and 620, the exemplary display unit 120 may have a predetermined number of virtual zones. Namely, the entire display area of the display unit 120 is divided into the virtual zones. In screen views 610 and 620, dividing lines and indicating marks (A1˜A9) are imaginary expressions included in the example only for a better understanding.

Although FIG. 6 shows nine virtual zones (A1˜A9) on the display unit 120, this is exemplary only and not to be considered as a limitation of this invention. The number of the virtual zones may be varied according to a user's setting, or according to the size of the display unit 120. More particularly, the control unit 160 may produce zone information by extracting a specific zone displaying a user's image data, especially face data 600, from the virtual zones A1 to A9. Namely, the control unit 160 may receive image data from the camera module 150, extract a user's face data 600 from the received image data through a face extraction algorithm, and then determine a zone in which the extracted face data 600 is located on the display unit 120.

For instance, if image data received from the camera module 150 is displayed as shown in the screen view 620, the control unit 160 may extract the user's face data 600 from the displayed image data. Then the control unit 160 may determine that the face data 600 is located in the A5 virtual zone among the virtual zones A1 to A9. Therefore, the control unit 160 may acquire the A5 zone information indicating the A5 virtual zone.

Additionally, according to the A5 zone information, the control unit 160 may determine display information used for displaying a three-dimensional user interface. Here, the control unit 160 may determine the direction of a user's visual perspective by analyzing the A5 zone information and thereby determine the display information containing a rotation angle and direction of a user interface. For instance, according to the A5 zone information, the control unit 160 may determine the A5 display information that indicates a central visual perspective from which a user looks at the device. Then the control unit 160 may control a display of a three-dimensional user interface based on the A5 display information.

Similarly, if receiving the face data 600 located on the A1 virtual zone, the control unit 160 may acquire the A1 zone information corresponding to the A1 virtual zone. Then, according to the A1 zone information, the control unit 160 may determine the A1 display information that indicates a left-upper visual perspective from which a user looks at the device, and may also control a display of a three-dimensional user interface based on the A1 display information.

Alternatively, if receiving the face data 600 located on the A2 virtual zone, the control unit 160 may acquire the A2 zone information corresponding to the A2 virtual zone. Then, according to the A2 zone information, the control unit 160 may determine the A2 display information that indicates an upper visual perspective from which a user looks at the device, and also control a display of a three-dimensional user interface based on the A2 display information.

In the same manner, if receiving the face data 600 located on the A3 virtual zone, the control unit 160 may acquire the A3 zone information corresponding to the A3 virtual zone. Then, according to the A3 zone information, the control unit 160 may determine the A3 display information that indicates a right-upper visual perspective from which a user looks at the device, and may also control a display of a three-dimensional user interface based on the A3 display information.

Similarly, if receiving the face data 600 located on one of the A4 to A9 virtual zones, the control unit 160 may acquire corresponding zone information and then determine specific display information that indicates one of a left, central, right, left-lower, lower, or right-lower visual perspectives from which a user looks at the device. Thereafter, based on the determined display information, the control unit 160 may control a display of a three-dimensional user interface. A related example is shown in FIG. 7.

Referring to FIG. 7, a screen view 710 shows three exemplary cases in which a user's face data 600 acquired through the camera module 150 is located in the A2, A5, or A8 virtual zone. When the device moves in any direction with respect to a stationary user's face, or vice versa, such face data 600 may vary according to a relative location of the user's face with respect to the device. Meanwhile, the face data 600 shown in the screen view 710 is an imaginary expression included in this example only for a better understanding. Actually, the face data 600 is not displayed on the screen, but instead a specific user interface is displayed, as shown in screen views 720 to 740.

The screen view 720 shows a user interface based on an upper visual perspective when the face data 600 is determined to be in the A2 virtual zone, as shown in the screen view 710. Namely, when the face data 600 is extracted from the A2 virtual zone, the control unit 160 acquires the A2 zone information that corresponds to the A2 virtual zone. Then, based on the A2 zone information, the control unit 160 determines the A2 display information that indicates an upper visual perspective from which a user looks at the device. Here, the A2 display information may contain conversion information that gives a stereoscopic effect to a user interface as if a user looks at the user interface from a central visual perspective. For instance, as illustrated, the conversion information may have specific information about a rotation angle and direction, so as to represent the upper part of a user interface that is far away as appearing smaller. Then, according to the A2 display information, the control unit 160 controls a display of a user interface as shown in the screen view 720.

Next, the screen view 730 shows a user interface based on a central visual perspective when the face data 600 is determined to be in the A5 virtual zone, as shown in the screen view 710. Namely, when the face data 600 is extracted from the A5 virtual zone, the control unit 160 acquires the A5 zone information that corresponds to the A5 virtual zone. Then, based on the A5 zone information, the control unit 160 determines the A5 display information that indicates a central visual perspective from which a user looks at the device. Here, the A5 display information may contain conversion information with no rotation angle and direction, so as to represent no part of a user interface being far away as appearing smaller. Then, according to the A5 display information, the control unit 160 controls a display of a user interface as shown in the screen view 730. Meanwhile, when the face data 600 is changed from the A2 virtual zone to the A5 virtual zone, the control unit 160 may offer a visual effect in order to represent a continuous variation in a user interface from the screen view 720 to the screen view 730.

Next, the screen view 740 shows a user interface based on a lower visual perspective when the face data 600 is determined to be in the A8 virtual zone, as shown in the screen view 710. Namely, when the face data 600 is extracted from the A8 virtual zone, the control unit 160 acquires the A8 zone information that corresponds to the A8 virtual zone. Then, based on the A8 zone information, the control unit 160 determines the A8 display information that indicates a lower visual perspective from which a user looks at the device. Here, the A8 display information may contain conversion information that gives a stereoscopic effect to a user interface as if the user looks at the user interface from a central visual perspective. For instance, as illustrated, the conversion information may have specific information about a rotation angle and direction so as to represent the lower part of a user interface that is far away as appearing smaller. Then, according to the A8 display information, the control unit 160 controls a display of a user interface as shown in the screen view 740.

As discussed herein with reference to FIGS. 6 and 7, the control unit 160 may determine the display information according to a specific zone of the display unit 120 in which the face data 600 is determined to be. Such display information may be mapped to each of zone information. For instance, if there are nine pieces of zone information respectively corresponding to nine virtual zones, nine pieces of display information may be respectively mapped thereto. In addition, values of rotation angle and direction in the display information may be predetermined as default or varied according to a user's setting.

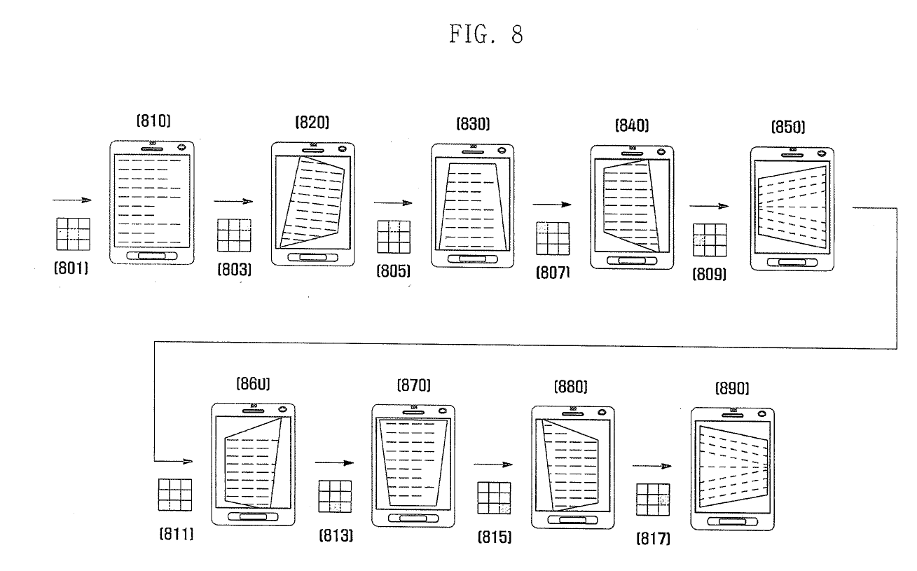

FIG. 8 is a view illustrating possible variations in a user interface of an electronic display device according to an exemplary embodiment of the present invention.

Referring to FIGS. 4 to 8, the control unit 160 of the device may convert a normal mode into a three-dimensional mode when receiving a user's request for a mode conversion. Also, the control unit 160 may begin to operate the camera module 150 and the UI processing unit 170 during a conversion into a three-dimensional mode.

Next, the control unit 160 may acquire zone information according to image data received from the camera module 150, in particular, according to a specific zone in which the face data 600 is determined to be. Also, the control unit 160 may determine display information from the acquired zone information and deliver it to the UI processing unit 170. Then, according to the display information, the UI processing unit 170 may convert a current user interface into a three-dimensional user interface.

Now, various examples of a three-dimensional user interface displayed according to the zone information and the display information will be described in detail. The order of examples shown in FIG. 8 is for illustration purposes only, and the present invention does not require a particular order.

If user's face data 600 is determined to be in the A5 virtual zone as indicated by a reference number 801, the control unit 160 acquires the A5 zone information and thereby determines the A5 display information corresponding to the central visual perspective. Then the UI processing unit 170 offers a user interface based on the central visual perspective as shown in a screen view 810. The user interface in this screen view 810 may be displayed in a sheet-like form that is the same as a normal user interface. Alternatively, the user interface in the screen view 810 may be displayed in a three-dimensional cubic form.

If the face data 600 is determined to be in the A3 virtual zone as indicated by a reference number 803, the control unit 160 acquires the A3 zone information and thereby determines the A3 display information corresponding to the right-upper visual perspective. Then the UI processing unit 170 offers a user interface based on the right-upper visual perspective as shown in a screen view 820. Here, the user interface in the screen view 820 has a stereoscopic effect as if a user looks at the user interface from the central visual perspective. Specifically, this user interface may be displayed in a sheet-like or cubic form that is rotated at a given angle and direction so as to represent three corner parts (except the left-lower part) that are far away as appearing smaller.

If the face data 600 is determined to be in the A2 virtual zone as indicated by a reference number 805, the control unit 160 acquires the A2 zone information and thereby determines the A2 display information corresponding to the upper visual perspective. Then the UI processing unit 170 offers a user interface based on the upper visual perspective as shown in a screen view 830. Here, the user interface in the screen view 830 has a stereoscopic effect as if a user looks at the user interface from the central visual perspective. Specifically, this user interface may be displayed in a sheet-like or cubic form that is rotated at a given angle and direction so as to represent the upper part that is far away as appearing smaller.

If the face data 600 is determined to be in the A1 virtual zone as indicated by a reference number 807, the control unit 160 acquires the A1 zone information and thereby determines the A1 display information corresponding to the left-upper visual perspective. Then the UI processing unit 170 offers a user interface based on the left-upper visual perspective as shown in a screen view 840. Here, the user interface in the screen view 840 has a stereoscopic effect as if a user looks at the user interface from the central visual perspective. More specifically, this user interface may be displayed in a sheet-like or cubic form that is rotated at a given angle and direction so as to represent three corner parts (except the right-lower part) that are far away as appearing smaller.

If the face data 600 is determined to be in the A4 virtual zone as indicated by a reference number 809, the control unit 160 acquires the A4 zone information and thereby determines the A4 display information corresponding to the left visual perspective. Then the UI processing unit 170 offers a user interface based on the left visual perspective as shown in a screen view 850. Here, the user interface in the screen view 850 has a stereoscopic effect as if a user looks at the user interface from the central visual perspective. Specifically, this user interface may be displayed in a sheet-like or cubic form that is rotated at a given angle and direction so as to represent the left part that is far away as appearing smaller.

If the face data 600 is determined to be in the A7 virtual zone as indicated by a reference number 811, the control unit 160 acquires the A7 zone information and thereby determines the A7 display information corresponding to the left-lower visual perspective. Then the UI processing unit 170 offers a user interface based on the left-lower visual perspective as shown in a screen view 860. Here, the user interface in the screen view 860 has a stereoscopic effect as if a user looks at the user interface from the central visual perspective. Specifically, this user interface may be displayed in a sheet-like or cubic form that is rotated at a given angle and direction so as to represent three corner parts (except the right-upper part) that are far away as appearing smaller.

If the face data 600 is determined to be in the A8 virtual zone as indicated by a reference number 813, the control unit 160 acquires the A8 zone information and thereby determines the A8 display information corresponding to the lower visual perspective. Then the UI processing unit 170 offers a user interface based on the lower visual perspective as shown in a screen view 870. Here, the user interface in the screen view 870 has a stereoscopic effect as if a user looks at the user interface from the central visual perspective. Specifically, this user interface may be displayed in a sheet-like or cubic form that is rotated at a given angle and direction so as to represent the lower part that is far away as appearing smaller.

If the face data 600 is determined to be in the A9 virtual zone as indicated by a reference number 815, the control unit 160 acquires the A9 zone information and thereby determines the A9 display information corresponding to the right-lower visual perspective. Then the UI processing unit 170 offers a user interface based on the right-lower visual perspective as shown in a screen view 880. Here, the user interface in the screen view 880 has a stereoscopic effect as if a user looks at the user interface from the central visual perspective. More specifically, this user interface may be displayed in a sheet-like or cubic form that is rotated at a given angle and direction so as to represent three corner parts (except the left-upper part) that are far away as appearing smaller.

If the face data 600 is determined to be in the A6 virtual zone as indicated by a reference number 817, the control unit 160 acquires the A6 zone information and thereby determines the A6 display information corresponding to the right visual perspective. Then the UI processing unit 170 offers a user interface based on the right visual perspective as shown in a screen view 890. Here, the user interface in the screen view 890 has a stereoscopic effect as if a user looks at the user interface from the central visual perspective. More specifically, this user interface may be displayed in a sheet-like or cubic form that is rotated at a given angle and direction so as to represent the right part that is far away as appearing smaller.

As fully discussed herein, this invention provides a graphical user interface dynamically changed according to a user's visual perspective, thus attracting a user's interest and enhancing a user's convenience.

Also, exemplary embodiments of the present invention capture a user's image in an electronic display device, acquires zone information from the captured image, determines display information according to the zone information, and then rotates a user interface according to the display information. Therefore, this invention provides a three-dimensional user interface adapted to a user's visual perspective.

Additionally, the user interface of an exemplary embodiment of the present invention is varied in real time according to a user's visual perspective, thus giving a stereoscopic effect as if the user looks at the user interface straight in the eye without rotating the device itself.

The above-described methods according to exemplary embodiments of the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an Application-Specific Integrated Circuit (ASIC) or Field-Programmable Gate Array (FPGA). As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While this invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a user interface, the method comprising:
activating a three-dimensional mode in response to a user's request;
determining a user's visual perspective according to a predefined user's input received in the three-dimensional mode; and
displaying a user interface converted according to the user's visual perspective.

2. The method of claim 1, wherein the determining of the user's visual perspective includes:
acquiring input information corresponding to the user's input; and
determining display information according to the input information, the display information being used to convert the user interface.

3. The method of claim 2, wherein the acquiring of the input information includes obtaining zone information received from a camera module.

4. The method of claim 3, wherein the obtaining of the zone information includes:
retrieving face data from image data received from the camera module;
determining a virtual zone in which the face data is determined to be; and
acquiring the zone information according to the virtual zone.

5. The method of claim 4, wherein the determining of the display information includes determining the display information according to the zone information based on the camera module.

6. The method of claim 5, wherein the displaying of the user interface includes:
retrieving conversion information about the user interface according to the display information; and
rotating the user information by an angle and in a direction according to the conversion information.

7. The method of claim 6, wherein the conversion information includes rotation angle information and rotation direction information for rotating the user interface according to the user's visual perspective corresponding to the zone information.

8. The method of claim 2, wherein the acquiring of the input information comprises one of touch information acquired through a touchpad or touch screen, remote information acquired through a remote controller, voice information acquired through a microphone, and motion information acquire through a motion sensor.

9. The method of claim 1, wherein the user interface is converted such that parts of the user interface are made smaller so as to appear farther away according to the user's visual perspective.

10. An electronic device, the device comprising:
a display unit configured to display a user interface;
a detecting member for providing input information for a three-dimensional conversion of the user interface; and
a control unit for determining a user's visual perspective based on the input information and for controlling a conversion of the user interface according to the user's visual perspective.

11. The device of claim 10, wherein the control unit acquires the input information from zone information received from a camera module.

12. The device of claim 11, wherein the control unit determines display information according to the input information, the display information being used to convert the user interface, and retrieves conversion information about the user interface according to the display information.

13. The device of claim 12, wherein the control unit includes a User Interface (UI) processing unit for converting the user interface in a three-dimensional manner according to the display information corresponding to the user's visual perspective.

14. The device of claim 13, wherein the UI processing unit rotates the user information by an angle and in a direction according to the conversion information.

15. The device of claim 14, wherein the conversion information includes rotation angle information and rotation direction information for rotating the user interface according to the user's visual perspective corresponding to the zone information.

16. The device of claim 15, further comprising a memory unit for storing the input information, the display information, and the conversion information.

17. The device of claim 11, wherein the control unit retrieves face data from image data received from the camera module, determines a virtual zone in which the face data is determined to be, and acquires the zone information according to the virtual zone.

18. The device of claim 17, wherein the display unit provides a predetermined number of the virtual zones.

19. The device of claim 10, wherein the detecting member detects one of touch information acquired through a touchpad or touch screen, voice information acquired through a microphone, and motion information acquire through a motion sensor.

20. The device of claim 10, wherein the user interface is converted such that parts of the user interface are made smaller so as to appear farther away according to the user's visual perspective.
